(19) United States
(12) Patent Application Publication
(10) Pub. No.: US 2026/0152980 A1
(43) Pub. Date: Jun. 4, 2026

(54) DOOR HANDLE DEVICE

(71) Applicant: AISIN CORPORATION, Kariya (JP)

(72) Inventors: Kazuya KATO, Kariya-shi (JP); Shota Yamada, Kariya-shi (JP)

(73) Assignee: AISIN CORPORATION, Kariya (JP)

(21) Appl. No.: 19/282,320

(22) Filed: Jul. 28, 2025

(30) Foreign Application Priority Data
Oct. 16, 2024 (JP) 2024-180705

(51) Int. Cl. E05B 85/16; E05B 81/16; E05B 81/76

(52) U.S. Cl. CPC E05B 85/16; E05B 81/16; E05B 81/76

(57) ABSTRACT

A door handle device includes: a door handle configured to become operable through a transition from a first state to a second state; a mechanical portion configured to cause a transition to a third state in which the door handle is further pulled out by a first stroke amount from the second state in response to an operation from a user in the second state, and to cause a transition to a fourth state in which the door handle is further pulled out by a second stroke amount from the third state in response to an operation from the user in the third state; and a signal generation unit configured to generate an electric signal based on a movement of the door handle from the second state to the third state.

### CROSS REFERENCE TO RELATED APPLICATIONS

This application is based on and claims priority under 35 U.S.C. § 119 to Japanese Patent Application 2024-180705, filed on Oct. 16, 2024, the entire content of which is incorporated herein by reference.

### TECHNICAL FIELD

This disclosure relates to a door handle device.

### BACKGROUND DISCUSSION

A so-called pop-up door handle becomes operated through a transition from a first state in which the door handle is pulled in along a surface of a door outer panel to a second state in which the door handle protrudes from the surface of the door outer panel. In this type of pop-up door handle, a technique is known in which the pop-up door handle is caused to transition from a pop-up second state to a third state in which the pop-up door handle is further pulled out and from the third state to a fourth state in which the pop-up door handle is further pulled out in response to an operation from a user in the third state.

Examples of the related art include WO 2018-137840 pamphlet (Reference 1).

In such a pop-up door handle, by implementing the transitions among the four states as described above, it is possible to implement electric unlocking of a door latch and mechanical unlocking of the door latch in this order in response to an increase in a manual pull-out stroke amount of the door handle from the second state.

However, in the related art as described above, in order to implement such a function, a relatively complicated structure (mechanical portion) is used, and there is a problem that the number of components is relatively large.

A need thus exists for a door handle device which is not susceptible to the drawback mentioned above.

### SUMMARY

According to an aspect of this disclosure, a door handle device includes: a door handle provided on a door outer panel side, the door handle being configured to become operable through a transition from a first state in which the door handle is pulled in along a surface of a door outer panel to a second state in which the door handle protrudes from the surface of the door outer panel; a mechanical portion configured to cause a transition to a third state in which the door handle is further pulled out by a first stroke amount from the second state in response to an operation from a user in the second state, and to cause a transition to a fourth state in which the door handle is further pulled out by a second stroke amount from the third state in response to an operation from the user in the third state; a signal generation unit configured to generate an electric signal based on a movement of the door handle from the second state to the third state; a door latch device mechanically connected to the mechanical portion; and a door latch drive unit configured to electrically drive the door latch device to be unlocked based on the electric signal. The mechanical portion includes a first bell crank, a second bell crank, and a lever, the first bell crank rotates from a first rotation position to a second rotation position about a first rotation shaft in response to a transition of the door handle from the second state to the third state, and rotates from the second rotation position to a third rotation position about the first rotation shaft in response to a transition of the door handle from the third state to the fourth state, the second bell crank rotates from a fourth rotation position to a fifth rotation position about a second rotation shaft in response to the transition of the door handle from the third state to the fourth state, the lever is coupled to the first bell crank and the second bell crank such that the second bell crank rotates from the fourth rotation position to the fifth rotation position in conjunction with rotation of the first bell crank from the second rotation position to the third rotation position, and rotation of the second bell crank from the fourth rotation position to the fifth rotation position causes the door latch device to mechanically operate to be unlocked.

### BRIEF DESCRIPTION OF THE DRAWINGS

The foregoing and additional features and characteristics of this disclosure will become more apparent from the following detailed description considered with the reference to the accompanying drawings, wherein:

FIG. 1 shows an example of a vehicle on which a door handle device according to an embodiment is mounted;

FIG. 1A is a schematic diagram showing a control system of the door handle device;

FIG. 2A shows a mechanical portion, and is a cross-sectional view of a main portion viewed from above;

FIG. 2B shows the mechanical portion, and is a cross-sectional view of the main portion viewed from below;

FIG. 3 shows an initial state (a stored state) of a door outside handle;

FIG. 3A is an enlarged view of a portion Q3 in FIG. 3;

FIG. 4 shows a pop-up state in which the door outside handle protrudes from a surface of a door outer panel;

FIG. 4A is an enlarged view of a portion Q4 in FIG. 4;

FIG. 5 shows an electric latch activation state in which the door outside handle is slightly pulled out from the pop-up state;

FIG. 5A is an enlarged view of a portion Q5 in FIG. 5;

FIG. 6 shows a manual unlock state in which the door outside handle is further pulled out from the electric latch activation state;

FIG. 6A is an enlarged view of a portion Q6 in FIG. 6; and

FIG. 7 is a perspective view showing further features of the mechanical portion.

### DETAILED DESCRIPTION

Hereinafter, an embodiment will be described in detail with reference to the accompanying drawings. Dimensional ratios in the drawings are merely examples and are not limited. Further, shapes and the like in the drawings may be partially exaggerated for the convenience of description. In the drawings, for the sake of clarity, a plurality of portions having the same attribute may be only partially denoted by reference signs.

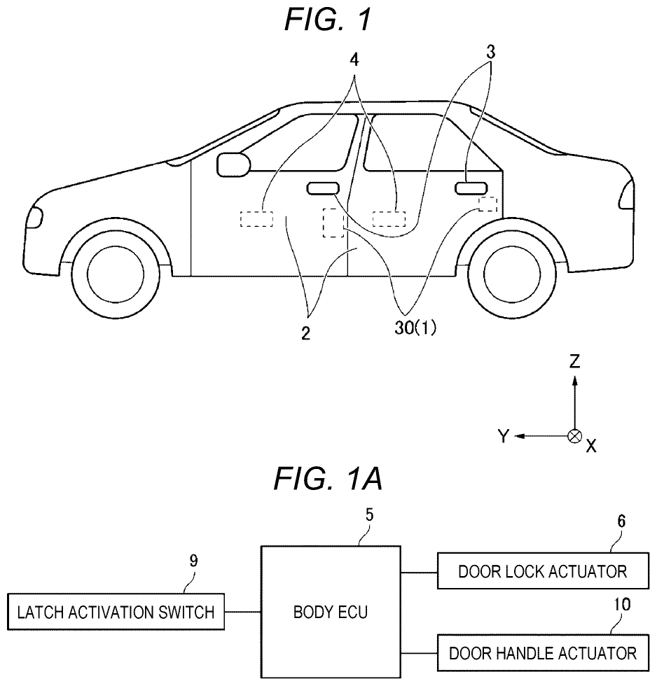

FIG. 1 shows an example of a vehicle on which a door handle device 1 according to the present embodiment is mounted. Note that the left and right door handle device s 1 of the vehicle may be configured symmetrically.

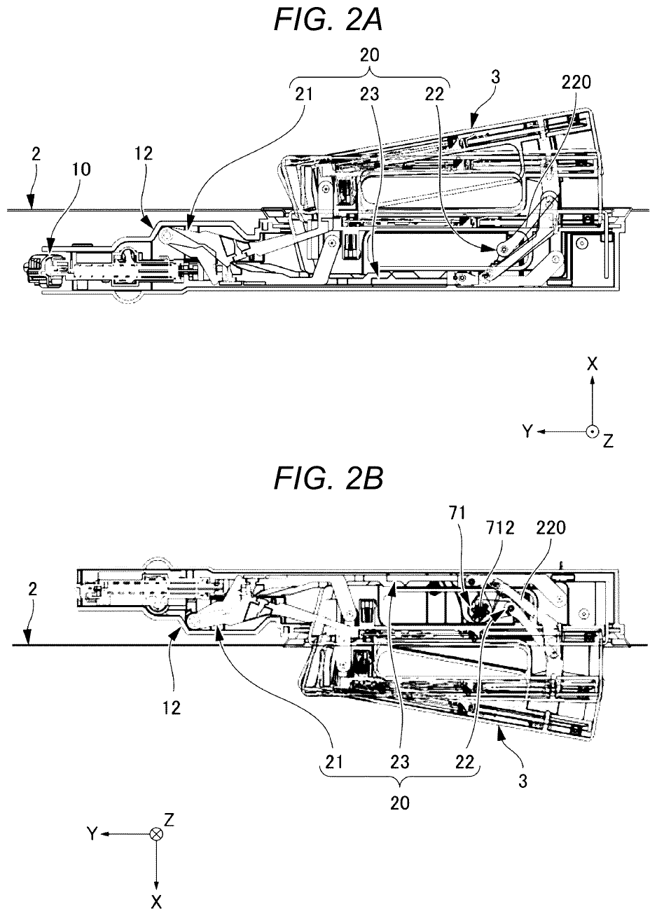

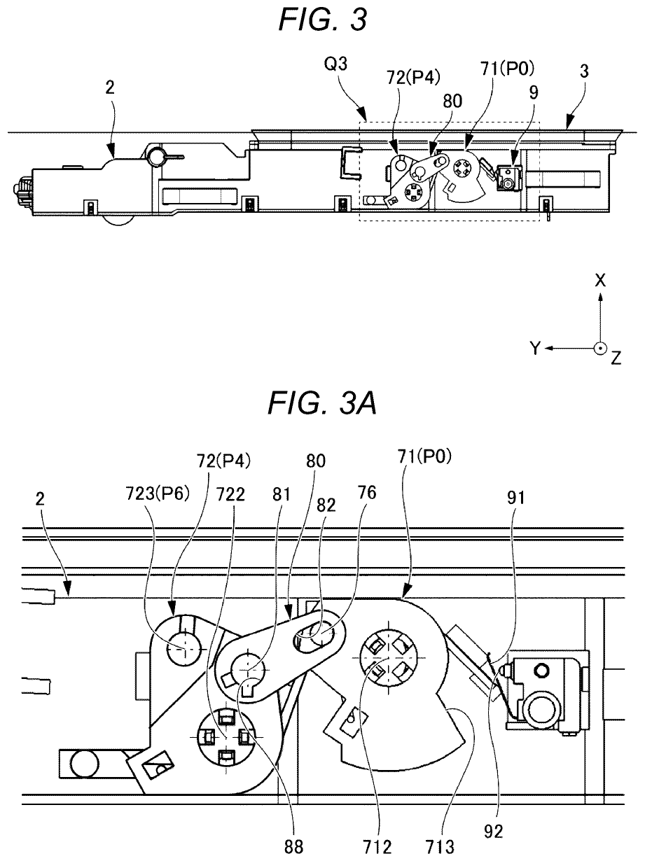

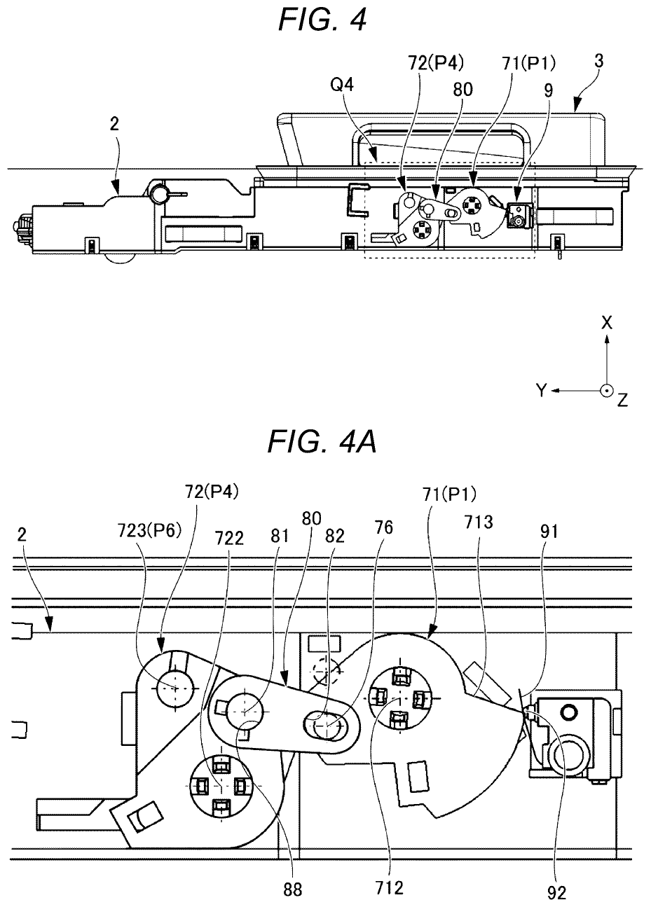

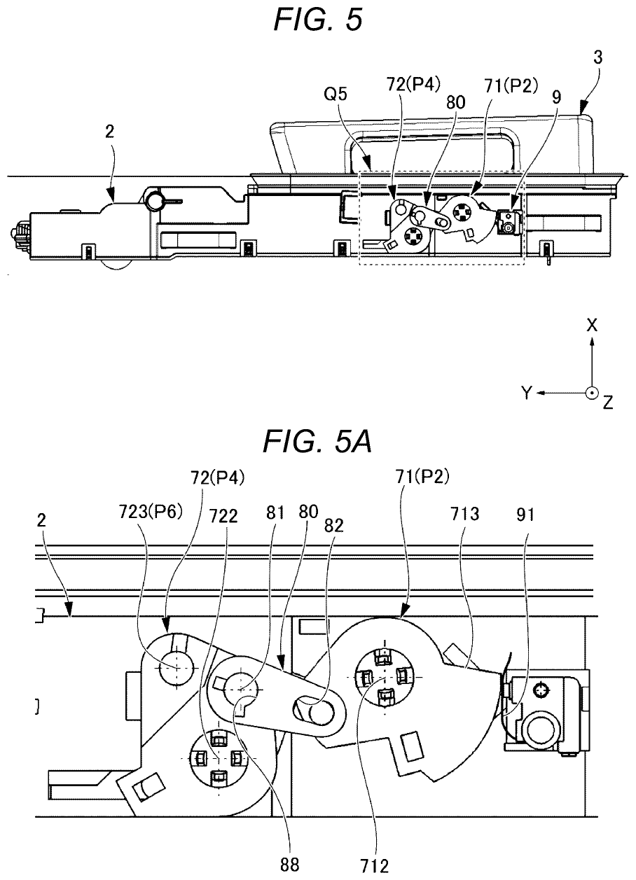

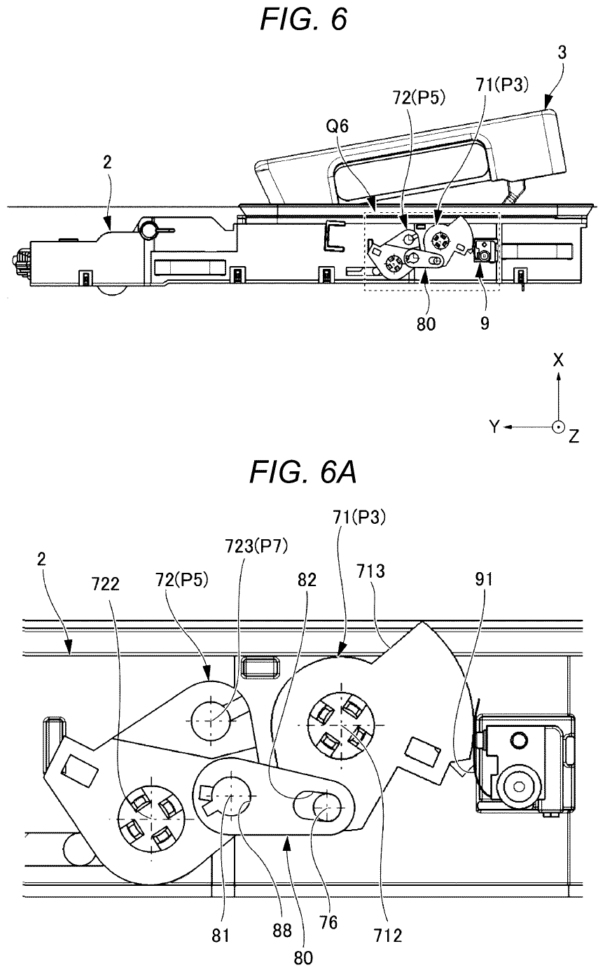

In FIG. 1 (and FIG. 2A, FIG. 2B, FIG. 3, FIG. 4, FIG. 5, and FIG. 6 described later), X, Y, and Z axes, which are three axes orthogonal to one another in a right-handed coordinate system, are shown. Here, an X direction corresponds to a vehicle width direction, and a positive side is a vehicle outer side. A Y direction corresponds to a vehicle front-rear direction, and a positive side in the Y direction is a front side. A Z direction corresponds to an upper-lower direction. However, actually, the vehicle width direction, the vehicle front-rear direction, and/or a vertical direction (gravity direction) may be slightly (for example, less than 20 degrees) inclined with respect to the X direction, the Y direction, and the Z direction. That is, the X direction, the Y direction, and the Z direction may have the vehicle width direction, the vehicle front-rear direction, and the vertical direction (gravity direction) as main direction components, respectively.

The door handle device 1 is incorporated in a door of a vehicle. That is, the door handle device 1 is mainly provided between a door outer panel 2 and a door inner panel (not shown) of the vehicle. The door of the vehicle in which the door handle device 1 is incorporated may be any door, and may be any door except for a back door.

The door outer panel 2 is provided with a door outside handle 3. The door outside handle 3 is of a pop-up type, and in an initial state, the door outside handle 3 is pulled in (stored) along a surface of the door outer panel 2. For example, the door outside handle 3 is stored inside the door (on a negative side in the X direction with respect to the door outer panel 2) such that a surface on a positive side in the X direction (the vehicle outer side) is substantially continuous with the surface of the door outer panel 2. Details of movements of the door outside handle 3 will be described later with reference to FIG. 3 and subsequent drawings.

The door handle device 1 includes a door latch device 30.

The door latch device 30 is mechanically connected to the door outside handle 3 and a door inside handle 4. The door latch device 30 operates in response to, for example, a user input via the door outside handle 3 or the door inside handle 4, and switches the door between a locked state and an unlocked state. The door latch device 30 causes a door lock actuator 6 (see FIG. 1A) to operate in response to an instruction from a body electronic control unit (ECU) 5 (see FIG. 1A) to cause the door to switch between the locked state and the unlocked state. Hereinafter, switching from the locked state to the unlocked state by such an operation of the door lock actuator is also referred to as “electric latch activation”.

FIG. 1A is a schematic diagram showing a control system of the door handle device 1.

The control system of the door handle device 1 is mainly implemented by the body ECU 5. The body ECU 5 is formed by a computer or the like. The body ECU 5 may have a function of controlling various in-vehicle devices (for example, a power window, and an electric seat) other than the door handle device 1.

The door lock actuator 6, a latch activation switch 9, and a door handle actuator 10 are connected to the body ECU 5.

When a door lock operation condition is satisfied, the body ECU 5 drives the door lock actuator 6 to cause the door latch device 30 to operate. The door lock operation condition is freely set. In the present embodiment, the door lock operation condition related to the switching of the door from the locked state to the door unlocked state is satisfied when the latch activation switch 9 is turned on from an off state (the initial state).

When a door handle operation condition is satisfied, the body ECU 5 drives the door handle actuator 10 to cause a mechanical portion 20 (described later) of the door handle device 1 to operate. The door handle operation condition is freely set, but in the present embodiment, the door handle operation condition related to the switching of the door outside handle 3 from the initial state (see FIG. 3) to a pop-up state (see FIG. 4) may be, for example, as follows. That is, the door handle operation condition may be satisfied when approaching of a legitimate user to the vehicle or a touch operation on a predetermined portion of the door outside handle 3 by the legitimate user is detected. In this case, the legitimate user is a user who possesses an electronic key that transmits radio waves including a legitimate identifier, and may be detected by the body ECU 5 via communication between an in-vehicle antenna (not shown) and the electronic key.

FIGS. 2A to 6A are diagrams schematically showing the door handle device 1 according to the present embodiment. FIG. 2A and FIG. 2B are diagrams of the mechanical portion 20, and FIG. 2A and FIG. 2B are a top view and a bottom view, respectively, of a cross section taken along the same XY plane. In FIGS. 2A and 2B, four states (the initial state, the pop-up state, an electric latch activation state, and a manual unlock state) described in detail below are shown in an overlapping manner. FIG. 3 shows the initial state (a stored state) of the door outside handle 3, and FIG. 3A is an enlarged view of a portion Q3 in FIG. 3. FIG. 4 shows the pop-up state in which the door outside handle 3 protrudes from the surface of the door outer panel 2, and FIG. 4A is an enlarged view of a portion Q4 in FIG. 4. FIG. 5 shows the electric latch activation state in which the door outside handle 3 is slightly pulled out from the pop-up state, and FIG. 5A is an enlarged view of a portion Q5 of FIG. 5. FIG. 6 shows the manual unlock state in which the door outside handle 3 is further pulled out from the electric latch activation state, and FIG. 6A is an enlarged view of a portion Q6 of FIG. 6.

The door handle device 1 further includes the door handle actuator 10, a case portion 12, and the mechanical portion 20.

The door handle actuator 10 operates based on a control signal from the body ECU 5. The door handle actuator 10 is mechanically coupled to the mechanical portion 20 and generates power for operating the mechanical portion 20. In the present embodiment, the door handle actuator 10 generates power for a transition from the initial state (FIG. 3, an example of a first state) to the pop-up state (see FIG. 4, an example of a second state).

The case portion 12 is fixed to the door outer panel 2. The case portion 12 supports the mechanical portion 20. For example, the case portion 12 fixes rotation shafts (a rotation shaft 712 and the like) parallel to a Z axis, which are rotation shafts of the mechanical portion 20. The case portion 12 may support the door handle actuator 10.

The mechanical portion 20 causes a state of the door outside handle 3 provided on a door outer panel 2 side to transition from the initial state (FIG. 3) to the electric latch activation state (FIG. 5, an example of a third state) or the manual unlock state (FIG. 6, an example of a fourth state) through the pop-up state (FIG. 4).

Details of the mechanical portion 20 are freely set as long as the door outside handle 3 can transition among such four states.

For example, the mechanical portion 20 may include a slider 23 that is translationally movable in the vehicle front-rear direction by the operation of the door handle actuator 10, and a plurality of link mechanisms 21, 22 that is movable in the XY plane. The plurality of link mechanisms 21, 22 is supported by the case portion 12 to be rotatable as described later. The slider 23 is supported by the case portion 12 to be slidable (translationally movable) in the Y direction.

In the example shown in FIGS. 2A and 2B, the plurality of link mechanisms 21, 22 may operate in conjunction with the translational movement of the slider 23 to cause the state of the door outside handle 3 to transition from the initial state (FIG. 3) to the pop-up state (FIG. 4). In addition, the plurality of link mechanisms 21, 22 may operate in conjunction with manual pull-out of the door outside handle 3 to implement a transition from the pop-up state (FIG. 4) to the electric latch activation state (FIG. 5) and a transition from the electric latch activation state (FIG. 5) to the manual unlock state (FIG. 6). The movements of the link mechanisms 21, 22 and the slider 23 (and the accompanying door outside handle 3) basically occurs in the XY plane.

Here, when a stroke of the door outside handle 3 at the time of the transition from the pop-up state (FIG. 4) to the electric latch activation state (FIG. 5) is defined as a first stroke, and a stroke of the door outside handle 3 at the time of the transition from the electric latch activation state (FIG. 5) to the manual unlock state (FIG. 6) is defined as a second stroke, the following relationship is preferably established in the present embodiment. That is, the second stroke is significantly larger than the first stroke. This is because the manual unlock state (FIG. 6) is for an emergency state (since it is not necessary in a normal state). That is, the unlocked state of the door may not be implemented in the electric latch activation state (FIG. 5) due to an abnormality in power supply for operating the door lock actuator 6, an abnormality in the latch activation switch 9, or the like. In this case, the emergency state in which the user can further pull out the door outside handle 3 to mechanically achieve the unlocked state of the door is the manual unlock state (FIG. 6). Therefore, by making the second stroke relatively large, it is possible to prevent the manual unlock state (FIG. 6) from occurring due to excessive momentum during a pull-out operation from the pop-up state (see FIG. 4) to the electric latch activation state (FIG. 5). In addition, by making the first stroke relatively small, it is also possible to prevent momentum during the pull-out operation from the pop-up state (see FIG. 4) to the electric latch activation state (FIG. 5).

In addition, from the same viewpoint, when an operation force on the door outside handle 3 necessary for the transition from the pop-up state (FIG. 4) to the electric latch activation state (FIG. 5) is defined as a first operation force, and an operation force on the door outside handle 3 necessary for the transition from the electric latch activation state (FIG. 5) to the manual unlock state (FIG. 6) is defined as a second operation force, the following relationship is preferably established in the present embodiment. That is, the second operation force is significantly larger than the first operation force. Accordingly, by making the second operation force relatively large, it is possible to prevent the manual unlock state (FIG. 6) from occurring due to the excessive momentum during the pull-out operation from the pop-up state (see FIG. 4) to the electric latch activation state (FIG. 5). Further, by making the first operation force relatively small, it is possible to improve operability of the pull-out operation from the pop-up state (see FIG. 4) to the electric latch activation state (FIG. 5).

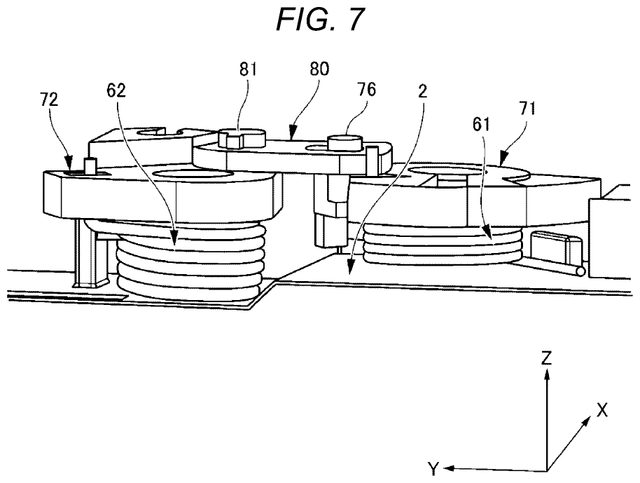

Next, more features of the mechanical portion 20 will be described with reference to FIG. 7 while continuously referring to FIGS. 2A to 6A.

FIG. 7 is a perspective view showing more features of the mechanical portion 20.

In the present embodiment, the mechanical portion 20 includes a first bell crank 71, a second bell crank 72, and a lever 80 as configurations having the more features.

The first bell crank 71 is supported by the case portion 12 to be rotatable about the rotation shaft 712 in the Z direction.

One end of a link 220 of the link mechanism 22 is rotatably coupled to the first bell crank 71 (see FIG. 2B). The first bell crank 71 rotates about the rotation shaft 712 in response to a movement of the link 220.

Specifically, the first bell crank 71 rotates from an initial position P0 (FIG. 3A) to a first rotation position P1 (FIG. 4A) about the rotation shaft 712 in response to the transition of the door outside handle 3 from the initial state (FIG. 3) to the pop-up state (FIG. 4).

The first bell crank 71 rotates from the first rotation position P1 (FIG. 4A) to a second rotation position P2 (FIG. 5A) about the rotation shaft 712 in response to the transition of the door outside handle 3 from the pop-up state (FIG. 4) to the electric latch activation state (FIG. 5).

The first bell crank 71 rotates from the second rotation position P2 (FIG. 5A) to a third rotation position P3 (FIG. 6A) about the rotation shaft 712 in response to the transition of the door outside handle 3 from the electric latch activation state (FIG. 5) to the manual unlock state (FIG. 6).

The first bell crank 71 is biased by a first spring 61 (see FIG. 7) in a direction to return to the initial position P0 about the rotation shaft 712. That is, the first bell crank 71 rotates from the initial position P0 to the third rotation position P3 against a rotational torque of the first spring 61. In this case, a biasing force of the first spring 61 correlates with the first operation force described above. Therefore, the biasing force (elastic modulus) of the first spring 61 is preferably set to be relatively small.

The first bell crank 71 has a portion 713 that operates the latch activation switch 9. In the present embodiment, as an example, the latch activation switch 9 is turned on when a plate spring 91 (leaf) comes into contact with a contact point 92. In this case, the portion 713 of the first bell crank 71 presses the plate spring 91 against the contact point 92 (that is, cause the latch activation switch 9 to turn on) in conjunction with the transition from the pop-up state (FIG. 4) to the electric latch activation state (FIG. 5).

The first bell crank 71 is provided with a pin 76 that constitutes a coupling portion with the lever 80 described later. The pin 76 is in a form of a protrusion protruding in the Z direction.

The second bell crank 72 is supported by the case portion 12 to be rotatable about a rotation shaft 722 in the Z direction.

The first bell crank 71 is coupled to the second bell crank 72 via the lever 80. Further, the second bell crank 72 is provided with a coupling portion 723 to which one end of a cable (not shown) is coupled. The other end of the cable (not shown) is coupled to the door latch device 30. Further, the second bell crank 72 is provided with a rotation shaft 81 constituting a coupling portion with the lever 80 described later.

The second bell crank 72 rotates from a fourth rotation position P4 to a fifth rotation position P5 about the rotation shaft 722 in response to the transition of the door outside handle 3 from the electric latch activation state (FIG. 5) to the manual unlock state (FIG. 6).

When the second bell crank 72 rotates from the fourth rotation position P4 (FIG. 5A) to the fifth rotation position P5 (FIG. 6A), the coupling portion 723 is displaced from a non-operation position P6 (FIG. 5A) to an operation position P7 (FIG. 6A). The non-operation position P6 and the operation position P7 are separated in the Y direction. Accordingly, the cable (not shown) causes the door latch device 30 to mechanically operate, and the transition of the door from the locked state to the unlocked state is implemented.

The second bell crank 72 is biased by the second spring 62 (see FIG. 7) in a direction to return to the fourth rotation position P4 about the rotation shaft 722. That is, the second bell crank 72 rotates from the fourth rotation position P4 to the fifth rotation position P5 against a rotational torque of the second spring 62. In this case, a biasing force of the second spring 62 correlates with the second operation force described above. Therefore, the biasing force (elastic modulus) of the second spring 62 is preferably set to be relatively large.

The lever 80 has one end coupled to the first bell crank 71 and the other end coupled to the second bell crank 72. The lever 80 operates in the XY plane similarly to the first bell crank 71 and the second bell crank 72.

Specifically, one end of the lever 80 is coupled to the first bell crank 71 such that the lever 80 is rotatable with respect to the first bell crank 71 and displaceable along a predetermined direction in the XY plane. The predetermined direction is a direction that changes in response to a posture of the lever 80 as viewed in the Z direction, and specifically corresponds to a longitudinal direction of a hole 82 of the lever 80. The hole 82 is an elongated hole and has a longitudinal direction. The pin 76 of the first bell crank 71 described above is inserted into the hole 82. In this case, the pin 76 is displaceable with respect to the hole 82 along the longitudinal direction of the hole 82, but is not displaceable when reaching end portions of the hole 82. The pin 76 can slide in a rotation (spin) direction in the hole 82.

The lever 80 has a shaft hole 88 into which the rotation shaft 81 is inserted at the other end of the lever 80, and is coupled to the second bell crank 72 via the rotation shaft 81. That is, the lever 80 is coupled to the second bell crank 72 to be rotatable about the rotation shaft 81 in the Z direction. As described above, the rotation shaft 81 is provided in the second bell crank 72 and moves integrally with the second bell crank 72. No significant gap (gap that enables significant relative displacement) as that between the hole 82 and the pin 76 is set between the shaft hole 88 and the rotation shaft 81.

As shown in FIGS. 3 to 5A, the lever 80 is coupled to the first bell crank 71 while mechanically separating the second bell crank 72 with respect to the rotation of the first bell crank 71 from the initial position P0 to the first rotation position P1 or the second rotation position P2. That is, the lever 80 is coupled to the first bell crank 71, such that the second bell crank 72 does not rotate in conjunction with the rotation of the first bell crank 71 from the initial position P0 to the second rotation position P2. Such coupling is implemented by the relationship between the hole 82 and the pin 76 described above. Specifically, the pin 76 in the hole 82 is displaced between one end and the other end in the longitudinal direction of the hole 82 at any rotation position from the initial position P0 to the second rotation position P2 of the first bell crank 71. More specifically, at the initial position P0 of the first bell crank 71, the pin 76 is located at one end (end portion on a negative side in the Y direction) in the longitudinal direction of the hole 82 (see FIG. 3A). At the second rotation position P2 of the first bell crank 71, the pin 76 is located at one end (end portion on a negative side in the Y direction) in the longitudinal direction of the hole 82 (see FIG. 5A). The pin 76 is located between one end and the other end in the longitudinal direction of the hole 82 at any rotation position between the initial position P0 and the second rotation position P2 of the first bell crank 71. Accordingly, it is possible to prevent the lever 80 from generating a rotational force that causes the second bell crank 72 to rotate via the hole 82 and the pin 76 at any rotation position between the initial position P0 and the second rotation position P2 of the first bell crank 71.

On the other hand, as shown in FIGS. 5 to 6A, the lever 80 causes the second bell crank 72 to rotate from the fourth rotation position P4 to the fifth rotation position P5 in conjunction with the rotation of the first bell crank 71 from the second rotation position P2 to the third rotation position P3. That is, the lever 80 is coupled to the first bell crank 71 such that the second bell crank 72 rotates in conjunction with the rotation of the first bell crank 71 from the second rotation position P2 to the third rotation position P3. Such coupling is implemented by the relationship between the hole 82 and the pin 76 described above. Specifically, at the second rotation position P2 of the first bell crank 71, the pin 76 is located at one end (end portion on a negative side in the Y direction) in the longitudinal direction of the hole 82 (see FIG. 5A). When the first bell crank 71 attempts to rotate from the second rotation position P2 to the third rotation position P3, a rotational force is generated in the lever 80 due to the pin 76 being not displaceable further (negative side in the Y direction) in the hole 82. That is, a rotational force that causes the second bell crank 72 to rotate is generated in the lever 80 via the hole 82 and the pin 76. Accordingly, the second bell crank 72 can be caused to rotate from the fourth rotation position P4 to the fifth rotation position P5 in conjunction with the rotation of the first bell crank 71 from the second rotation position P2 to the third rotation position P3.

As described above, according to the present embodiment, regarding the pop-up door handle, electric unlocking and mechanical unlocking can be sequentially implemented in response to an increase in a pull-out stroke of the door outside handle 3 by using a relatively simple structure including the first bell crank 71, the second bell crank 72, and the lever 80.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

Regarding the above embodiment, the following appendixes are further disclosed.

### Appendix 1

A door handle device, including:
a door handle provided on a door outer panel side, the door handle being configured to become operable through a transition from a first state in which the door handle is pulled in along a surface of a door outer panel to a second state in which the door handle protrudes from the surface of the door outer panel;
a mechanical portion configured to cause a transition to a third state in which the door handle is further pulled out by a first stroke amount from the second state in response to an operation from a user in the second state, and to cause a transition to a fourth state in which the door handle is further pulled out by a second stroke amount from the third state in response to an operation from the user in the third state;
a signal generation unit configured to generate an electric signal based on a movement of the door handle from the second state to the third state;
a door latch device mechanically connected to the mechanical portion; and
a door latch drive unit configured to electrically drive the door latch device to be unlocked based on the electric signal, in which
the mechanical portion includes a first bell crank, a second bell crank, and a lever,
the first bell crank rotates from a first rotation position to a second rotation position about a first rotation shaft in response to a transition of the door handle from the second state to the third state, and rotates from the second rotation position to a third rotation position about the first rotation shaft in response to a transition of the door handle from the third state to the fourth state,
the second bell crank rotates from a fourth rotation position to a fifth rotation position about a second rotation shaft in response to the transition of the door handle from the third state to the fourth state,
the lever is coupled to the first bell crank and the second bell crank such that the second bell crank rotates from the fourth rotation position to the fifth rotation position in conjunction with rotation of the first bell crank from the second rotation position to the third rotation position, and
rotation of the second bell crank from the fourth rotation position to the fifth rotation position causes the door latch device to mechanically operate to be unlocked.

### Appendix 2

The door handle device according to Appendix 1, in which
the lever is coupled to the first bell crank such that rotation of the second bell crank in conjunction with rotation of the first bell crank from the first rotation position to the second rotation position does not occur.

### Appendix 3

The door handle device according to Appendix 2, in which
the first bell crank has a protrusion in an upper-lower direction,
the lever has, at one end, a hole into which the protrusion is inserted, and at the other end, a supported portion rotatably supported by the second bell crank,
the hole is an elongated hole in which the protrusion is displaceable along a longitudinal direction of the hole, and
the protrusion is displaced with respect to the hole in conjunction with the rotation of the first bell crank from the first rotation position to the second rotation position, and on the other hand, is not displaceable with respect to the hole when the first bell crank rotates from the second rotation position to the third rotation position.

### Appendix 4

The door handle device according to at least one of Appendixes 1 to 3, in which
the second stroke amount is larger than the first stroke amount.

### Appendix 5

The door handle device according to at least one of Appendixes 1 to 4, wherein
the rotation of the first bell crank from the first rotation position to the second rotation position causes the signal generation unit to generate the electric signal.

In one aspect, according to the present disclosure, in a pop-up door handle, it is possible to sequentially implement electric unlocking and mechanical unlocking in response to an increase in a pull-out stroke of the door handle using a relatively simple structure.

What is claimed is:

1. A door handle device, comprising:
a door handle provided on a door outer panel side, the door handle being configured to become operable through a transition from a first state in which the door handle is pulled in along a surface of a door outer panel to a second state in which the door handle protrudes from the surface of the door outer panel;
a mechanical portion configured to cause a transition to a third state in which the door handle is further pulled out by a first stroke amount from the second state in response to an operation from a user in the second state, and to cause a transition to a fourth state in which the door handle is further pulled out by a second stroke amount from the third state in response to an operation from the user in the third state;
a signal generation unit configured to generate an electric signal based on a movement of the door handle from the second state to the third state;
a door latch device mechanically connected to the mechanical portion; and
a door latch drive unit configured to electrically drive the door latch device to be unlocked based on the electric signal, wherein
the mechanical portion includes a first bell crank, a second bell crank, and a lever,
the first bell crank rotates from a first rotation position to a second rotation position about a first rotation shaft in response to a transition of the door handle from the second state to the third state, and rotates from the second rotation position to a third rotation position about the first rotation shaft in response to a transition of the door handle from the third state to the fourth state,
the second bell crank rotates from a fourth rotation position to a fifth rotation position about a second rotation shaft in response to the transition of the door handle from the third state to the fourth state,
the lever is coupled to the first bell crank and the second bell crank such that the second bell crank rotates from the fourth rotation position to the fifth rotation position in conjunction with rotation of the first bell crank from the second rotation position to the third rotation position, and
rotation of the second bell crank from the fourth rotation position to the fifth rotation position causes the door latch device to mechanically operate to be unlocked.

2. The door handle device according to claim 1, wherein
the lever is coupled to the first bell crank such that rotation of the second bell crank in conjunction with rotation of the first bell crank from the first rotation position to the second rotation position does not occur.

3. The door handle device according to claim 2, wherein
the first bell crank has a protrusion in an upper-lower direction,
the lever has, at one end, a hole into which the protrusion is inserted, and at the other end, a supported portion rotatably supported by the second bell crank,
the hole is an elongated hole in which the protrusion is displaceable along a longitudinal direction of the hole, and
the protrusion is displaced with respect to the hole in conjunction with the rotation of the first bell crank from the first rotation position to the second rotation position, and on the other hand, is not displaceable with respect to the hole when the first bell crank rotates from the second rotation position to the third rotation position.

4. The door handle device according to claim 1, wherein
the rotation of the first bell crank from the first rotation position to the second rotation position causes the signal generation unit to generate the electric signal.

5. The door handle device according to claim 2, wherein
the rotation of the first bell crank from the first rotation position to the second rotation position causes the signal generation unit to generate the electric signal.

6. The door handle device according to claim 3, wherein
the rotation of the first bell crank from the first rotation position to the second rotation position causes the signal generation unit to generate the electric signal.
